(19) United States
(12) Patent Application Publication
(10) Pub. No.: US 2021/0222001 A1
(43) Pub. Date: Jul. 22, 2021

(54) HYDROPHOBIC COATINGS COMPRISING HYBRID MICROSPHERES WITH NANO/MICRO ROUGHNESS

(71) Applicant: NITTO DENKO CORPORATION, Osaka (JP)

(72) Inventors: Guang Pan, Carlsbad, CA (US); Kaoru Ueno, Fallbrook, CA (US); Bin Zhang, San Diego, CA (US)

(21) Appl. No.: 17/057,510

(22) PCT Filed: May 31, 2019
(86) PCT No.: PCT/US2019/034878

§ 371 Date: Nov. 20, 2020

Related U.S. Application Data
(60) Provisional application No. 62/678,389, filed on May 31, 2018.

(51) Int. Cl. C08L 69/00; C09D 7/65; C09D 7/62; C09D 169/00; C09D 133/12

(52) U.S. Cl. CPC C08L 69/00; C09D 7/65; C09D 133/12; C09D 169/00; C09D 7/62

(57) ABSTRACT

Described herein are coatings based on a hydrophobic polymer matrix and hydrophobic nanoparticles that provide a damage tolerant hydrophobic, superhydrophobic, and/or snowphobic capability, wherein the nanoparticles can comprise modified and phyllosilicate nanoclays. The micro and nano roughness of the composite surface is described. Methods of creating snow resistant materials by employing the aforementioned coatings are also described.

### CROSS-REFERENCE TO RELATED APPLICATIONS

This application claims the benefit of U.S. Provisional Application No. 62/678,389, filed May 31, 2018, which is incorporated by reference herein in its entirety.

### FIELD

The present disclosure relates to hydrophobic, superhydrophibic and snowphobic composites, including coatings of the composites for such uses as water, ice and snow repellents.

### BACKGROUND

In many settings, the buildup of water, ice, and snow can create undesirable results. These issues can include corrosion due to water intrusion, loss of visibility due to water buildup, and ice and snow buildup on roads, vehicles and buildings. On windshields of motor craft such as automobiles, boats, and aircraft, complex systems including wipers, air jets, and passive systems such as deflectors, are designed to remove water. The buildup of ice on the leading edges and on the upper wing surfaces of airplanes and rotor blades of helicopters can create hazardous conditions by changing the shape of the wing and/or increasing the total weight, resulting in stall or loss of performance. In addition, deposited ice can suddenly dislodge resulting in an unexpected change in characteristics and possibly loss of control. Ice and snow buildup on walkways, roadways, and bridges is inherently dangerous due to loss of traction. Highway overpasses, bridges, and power lines may create hazardous conditions by falling ice and snow, resulting in damage to vehicles and personal injury to persons below.

There are many kinds of snow having vastly divergent water contents. For example, dry or light snow has a very low water content, while heavy or wet snow has a high water content. The considerable difference in water content creates a problem with respect to anti-snow performance of known hydrophobic coatings. Wet snow creates a water layer between the conventional hydrophobic coatings and the snow which allows the hydrophobic coating to interact with the water, and due to the high water contact angle the water layer will slide off the coating taking along the upper layer of snow. Dry snow on the other hand, with its low water content, forms minimal to no water layer between the snow and known hydrophobic coatings. This lack of a water layer causes the dry snow to accumulate on the surface.

To combat ice and snow accretion on roadways, signage and power lines, many municipalities use anti-snow/anti-ice materials such as fluorinate resin based coatings. While some of these coatings are commercially available (e.g., HIREC100), they can be expensive to produce, difficult to work with, and may be harmful to both animals and humans.

As a result, there is a continuing need for a new anti-snow surface coating with improved hydrophobic performance, reduced cost, and low toxicity.

### SUMMARY

The present disclosure generally relates to composites. More particularly, but not exclusively, the present disclosure relates to a composite comprising microspheres dispersed within and protruding through a polymer matrix. In some embodiments, the present disclosure relates to a composite comprising a nano/micro rough surface. Some embodiments include a hydrophobic coating comprising the polymer/microsphere composite.

Some embodiments include a hydrophobic composite, comprising: a polymer matrix, comprising a first matrix polymer, wherein the first matrix polymer has a surface energy of at least 30 mJ/m²; a plurality of microspheres, comprising a core and a hydrophobic coating surrounding the circumference of the core, wherein: the microsphere core comprises an acrylic polymer; and the microsphere coating comprises hydrophobic nanoparticles.

Some embodiments include a coating comprising a hydrophobic composite described herein, wherein the coating is superhydrophobic or snowphobic.

Some embodiments include a method for preparing a coating for a casting application, comprising: mixing an amount of a matrix polymer and a solvent to create a solution; adding surface modified microspheres and mixing to form a slurry; casting the slurry upon a substrate; and drying the coated substrate at a temperature of about 100° C. for about 1 h.

Some embodiments include a method of treating a surface, comprising applying a composite described herein to a surface in need of treatment. In some embodiments, a method of surface treatment comprises spray coating a composite described herein to a surface in need of treatment.

### BRIEF DESCRIPTION OF THE DRAWINGS

FIG. 1 is a depiction of a microsphere encapsulated by hydrophobic nanoparticles.

FIG. 2 is a depiction of a microsphere encapsulated by hydrophobic nanoparticles.

FIGS. 3A-3D are SEM photographs of 2 micron, 4 micron, 6 micron, and 8 micron template microspheres.

FIG. 4 is a drawing depiction of a possible embodiment of a coating with a micro/nano rough surface.

FIG. 5 is a SEM photographs depicting a micro/nano rough surface of an embodiment in differing scale.

FIG. 6 is a depiction and corresponding SEM photograph comparing micro/nano roughness on the surface of a possible embodiments.

FIG. 7 is a representation of the snow sliding test.

### DETAILED DESCRIPTION

Generally, the hydrophilic composites described herein comprise a first matrix polymer, a core polymer, and hydrophobic nanoparticles. The first matrix polymer is a polymer that is present in the polymer matrix. The polymer matrix acts as a host or matrix for a plurality of microspheres. For example, the microspheres can be dispersed throughout, within and upon the matrix outer surface, or the surface opposite the surface upon which the matrix is deposited (e.g. the surface that is intended to become more hydrophobic, superhydrophobic, or snowphobic). Each microsphere comprises a core, comprising the core polymer, and a hydrophobic coating on the surface of the core. The hydrophobic coating comprises hydrophobic nanoparticles and, optionally, a hydrophobic coating polymer.

The first matrix polymer may be a high surface energy polymer, e.g., polycarbonate or poly (n-butylmethacrylate). The composite may comprise a second matrix polymer that be a low surface energy polymer, so that the first matrix polymer may have a higher surface energy than the second matrix polymer.

In some embodiments, the core polymer is an acrylic polymer, such as poly(methylmethacrylate) (PMMA). In some embodiments, the acrylic polymer can be in the form of beads, the beads having an average diameter of about 1 μm (micron or micrometer) to about 100 μm.

In some embodiments, the microspheres can comprise a hydrophobic coating surrounding the core. In some embodiments, the hydrophobic coating can comprise a plurality of hydrophobic nanoparticles. In some embodiments, the hydrophobic coating can comprise a fluorinated metal silicate, e.g. a perfluorinated metal silicate. In some embodiments, the fluorinated metal silicate comprises a fluorinated aluminum silicate, a fluorinated aluminum magnesium silicate, or a fluorinated magnesium silicate. In some embodiments, the metal silicate can be fluoroalkyl modified halloysite materials. In some embodiments, at least a portion of the hydrophobic nanoparticles extend radially outward from the surface of the microsphere. In some embodiments, the arrangement of the microspheres on the matrix outer surface forms cavities. These cavities among the microspheres may provide a micro roughness. In some embodiments, the spaces between the hydrophobic nanoparticles define a nano roughness.

In some embodiments, the first matrix polymer has a surface energy of at least 30 mJ/m². In some embodiments, the second matrix polymer has a surface energy of up to 22 mJ/m². In some embodiments, the matrix polymer comprises a thermoplastic polymer. In some embodiments, the thermoplastic polymer can be a polycarbonate. In some embodiments, the second matrix polymer can be an alkylsilane. In some embodiments, the second matrix polymer can be a polysiloxane. In some embodiments, the polysiloxane can be a polydimethylsiloxane. In some embodiments, the acrylic cores have a radius or a diameter of about 1 μm to about 100 μm. In some embodiments, the protruding microspheres provide a micro roughness of about 0.1 μm to about 50 μm to the surface of the hydrophobic composite. In some embodiments, the hydrophobic nanoparticles within the coating can provide a nano roughness of about 10 nm to about 500 nm.

Some embodiments include a method for making a coating. The method can comprise combining a polymer (e.g., poly(methylmethacrylate) [PMMA]), a solvent, a fluorinated nanoparticle, and a matrix polymer (e.g. polycarbonate), then mixing with milling beads for at least 16 hours. In some embodiments, the method can comprise preparing a hydrophobic preformed polymer core, composed of the core polymer, with a fluorinated metal silicate. The method can comprise mixing the hydrophobic preformed polymer core with the polymer solution. In some embodiments, the resultant slurry is then applied to the desired surface. In some embodiments, a film is made using the resultant slurry. In some embodiments, the slurry can be applied by spray application. In some embodiments, the coating mixture can comprise a hydrophobic coating polymer, which may have a low surface energy. In some examples, the hydrophobic coating polymer and/or a second matrix polymer can be polydimethylsiloxane. In some embodiments, the matrix polymer can be polycarbonate. In some embodiments, the core polymer can be poly(n-butylmethacrylate). In some embodiments, the PMMA beads have an average diameter of 1 μm (micron or micrometer) to about 100 μm. In some embodiments, the fluorinated hydrophilic nanoparticles can be fluorinated metal silicate. In some embodiments, the fluorinated metal silicate can be fluorinated aluminum silicate. In some embodiments, the fluorinated hydrophilic nanoparticles can be fluorinated halloysite.

The present disclosure relates to hydrophobic, superhydrophobic, and/or snowphobic composites that can be useful as coatings for anti-ice and anti-snow applications. “Hydrophobic” and “superhydrophobic” composites include composites that are hydrophobic, highly hydrophobic, or water repellant. Water repellency may be measured by the contact angle of a droplet of water on a surface. If the water, contact angle is at least 90 degrees it is said to be hydrophobic. If the water, contact angle is at least 150 degrees it is said to be superhydrophobic.

“Bulk composites” are composites, coatings, paints, etc., that exhibit hydrophobic, superhydrophobic and/or snowphobic properties throughout the composite, coating, paint, etc., instead of only on the surface. This may provide an advantage, in that, if the surface is eroded or ablated, the remaining surface retains its phobicity. Thus, some bulk composites described herein are damage tolerant such that the phobic properties are retained after being eroded.

One way to determine whether a composite has bulk hydrophobicity and/or bulk superhydrophobicity is by removing the surface and some amount of the underlying material by abrasion, and measuring the contact angle after abrasion. For example, the contact angle may be measured after 5-8 μm, 5-6 μm, 5 μm, 6 μm, 6-7 μm, 7 μm, 7-8 μm, or 8 μm of the material from the surface has been removed by abrasion. In some embodiments, the composite retains or gains its superhydrophobic properties (e.g., contact angle) after abrasion.

“Snowphobic” or snow phobicity as used here in refers to composites wherein snow, with water content in the range of 0-20 wt % and snow loading of 1.0 g/cm², will slide off a composite treated substrate with an inclining angle of 30 degrees or greater and within 1-3 minutes of the snow accumulation. Not only will the snow slide off the treated substrate, but the treated substrate will, at maximum, experience less than 20% area coverage with snow prior to the snow sliding.

As used herein the term “compatibilization” has the meaning known by those of ordinary skill in the art. Compatibilization refers to adding a substance that when added to an immiscible (or incompatible) blend of polymers, increases the polymer blends stability of the polymer blend, by creating interactions between the two immiscible polymers.

Some embodiments include composites useful in the repellency of water, snow and/or ice. In some embodiments, the composite can be a coating. In some embodiments, the coating can have a thickness in a range of about 10 μm to about 1000 μm, or about 20 μm, about 25 μm, about 30 μm, about 35 μm about 46 μm, about 79 μm, about 106 μm, or in a range bounded by any of these values.

Some embodiments include composites useful in repelling water, snow and/or ice. In some embodiments, a composite may at least have no snow adhesion, where snow keeps sliding off the test area. In some embodiments, a composite may at least have snow crystals adhering to the surface but sliding off the surface after about every 10 seconds of accumulation with an average coverage area of about 20%. In some embodiments, a composite may at least have snow crystals adhering to the surface with snow sliding off after about every 30 seconds to 1 minute of accumulation. In some embodiments, a composite may at least have the average snow accumulation on more than 80% of the test area with snow sliding after every 3-5 minutes of accumulation. In some embodiments, a composite may exhibit the aforedescribed snow adhesion at 30°, 45°, and/or 60° surface angle.

In some embodiments, a coating can comprise the composite. In some embodiments, the composite can comprise a polymer matrix, having an outer surface. In some examples, the surface of the polymer matrix, opposite to the outer surface, is a surface bound to the substrate. In some embodiments, at least some of the microspheres are dispersed in the matrix or the outer surface of the composite. In some embodiments, the coating can comprise a plurality of hydrophobic nanoparticles disposed upon the core surface. In some embodiments, at least some of the microspheres can be dispersed within the outer surface of the polymer matrix.

In some embodiments, the composite can be in any suitable form, such as a solid, e.g., a composite solid or a homogeneous solid. For example, various components of the composite can be mixed such that they form a substantially uniform mixture. In some embodiments, components of the composite can be crosslinked, and may, for example, form a polymer matrix. In some embodiments, some of the materials can be loaded into the matrix. In some embodiments, the composite can form a coating, e.g., a paint, an epoxy, a powder coating, or the like.

Polymer Matrix

Some embodiments include a polymer matrix having an outer matrix surface. In some embodiments, the surface opposite to the outer matrix surface is a surface bound to a substrate. The matrix comprises a high surface energy and/or first matrix polymer. In some embodiments, the matrix polymer can have a surface free energy of at least 30 mJ/m² (for the purposes of this disclosure, mJ/m² and mN/m are considered to be equivalent and may be used interchangeably as the dimensional formula of surface energy). In some embodiments, the matrix can comprise a low surface energy polymer and/or second matrix polymer. In some embodiments, the low surface energy or second matrix polymer can have a surface free energy of less than or equal to 22 mJ/m², e.g., 20 mJ/m². In some embodiments, the first matrix polymer and the second matrix polymer can have sufficiently dissimilar surface energies such that the high surface energy polymer and the low surface energy polymer can be to be immiscible within each other.

The first matrix polymer can be any suitable polymer, including any suitable high surface energy polymer, such as a polycarbonate (PC, [34.2 mN/m at 20° C.]) a polymethylmethacrylate (PMMA, [41.1 mN/m at 20° C]), a polystyrene (PS, [40.7 mN/m at 20° C]), a polyvinylidene fluoride (PVDF, [30.3 mN/m at 20° C]), a polyvinyl fluoride (PVF, [36.7 mN/m at 20° C]), a polyisobutylene (PIB, [33.6 mN/m at 20° C]), a polypropylene-isotactic (PP, [30.1 mN/m at 20° C]), a Polyethylene-linear (PE, [35.7 mN/m at 20° C]), a polyethylene-branched (PE, [35.3 mN/m at 20° C]), a polyvinylchloride (PVC, [41.5 mN/m at 20° C]), a polyvinylacetate (PVA, [36.5 mN/m at 20° C]), a polymethylacrylate (PMAA, [41.0 mN/m at 20° C]), a polyethylacrylate (PEA, [41.1 mN/m at 20° C]), a polyethylmethacraylate (PEMA, [35.9 mN/m at 20° C]), a polybutylmethacraylate (PBMA, [31.9 mN/m at 20° C.]) a polyisobutylmethacraylate (PIBMA, [30.9 mN/m at 20° C]), a poly(t-butylmethacrylate) (PtBMA, [30.4 mN/m at 20° C]), a polyhexylmethacrylate (PHMA, [30.0 mN/m at 20° C]), a polytetramethylene oxide (PTME, [31.9 mN/m at 20° C.]) a polyalkylene, etc. In some embodiments, one of the polymers comprises a polycarbonate. In some embodiments, one of the polymers comprises a polystyrene.

In some embodiments, the first matrix polymer can comprise a thermoplastic polymer. In some embodiments, the thermoplastic polymer can comprise a polycarbonate. In some embodiments, the thermoplastic polymer can comprise a polystyrene. In some embodiments, the thermoplastic polymer can comprise poly(n-butylmethacrylate).

In some embodiments, the first matrix polymer has a surface energy of about 30-45 mN/m, about 30-31 mN/m, about 31-32 mN/m, about 32-33 mN/m, about 33-34 mN/m, about 34-35 mN/m, about 35-36 mN/m, about 36-37 mN/m, about 37-38 mN/m, about 38-39 mN/m, about 39-40 mN/m, about 40-41 mN/m, about 41-42 mN/m, about 42-43 mN/m, about 43-44 mN/m, about 44-45 mN/m, about 30-33 mN/m, about 33-36 mN/m, about 36-39 mN/m, about 39-42 mN/m, about 42-45 mN/m, about 30-35 mN/m, about 35-40 mN/m, or about 40-45 mN/m.

The second matrix polymer may be any suitable low surface energy polymer, such as a polyalkylsiloxane, a polydimethylsiloxane (PDMS, or a silicone, [19.8 mN/m at 20° C]), a polytrifluoroethylene (P3FEt/PTrFE, [23.9 mN/m at 20° C]), or a polytetrafluoroethylene (PTFE/Teflon™ [20 mN/m at 20° C]).

In some embodiments the second matrix polymer can comprise an organosilicon material. In some embodiments, the organosilicon material can be an alkylsilane. In some embodiments, the alkylsilane can be polydimethylsilane (polydimethylsiloxane) (PDMS). In some embodiments, the PDMS may be a suitable commercially available embodiment, for example Sylgard® 184 (DOW Corning, Midland, Mich. USA).

In some embodiments, the second matrix polymer has a surface energy of about 15-25 mN/m, about 15-16 mN/m, about 16-17 mN/m, about 17-18 mN/m, about 18-19 mN/m, about 19-20 mN/m, about 20-21 mN/m, about 21-22 mN/m, about 22-23 mN/m, about 23-24 mN/m, about 24-25 mN/m, about 15-17 mN/m, about 17-19 mN/m, about 19-21 mN/m, about 21-23 mN/m, about 23-25 mN/m, about 15-18 mN/m, about 18-21 mN/m, about 21-25 mN/m, about 15-20 mN/m, or about 20-25 mN/m.

In some embodiments, the first matrix polymer can be polycarbonate and the second matrix polymer can be polydimethylsiloxane. In these embodiments, the mass ratio of polydimethylsiloxane to polycarbonate can be in a range from about 0.3-1 (3 g of polydimethylsiloxane and 10 grams of polycarbonate is a mass ratio of 0.3), about 0.3-0.4, about 0.4-0.5, about 0.5-0.6, about 0.6-0.7, about 0.3-0.5, about 0.6-0.8, about 0.7-0.9, about 0.8-1, about 0.3-1, about 0.6-1.2, about 1-1.4, about 1.2-1.6, about 1.4-1.8, about 1.6-2, about 1-2, about 2-3, about 3-4, about 4-5, about 2-5, about 5-6, about 6-7, about 7-8, about 8-9, about 9-10, about 5-10, about 2.2-2.7, about 2.3, about 2.6, about 2.4, or any mass ratio in a range bounded by any of these values.

In some embodiments, the first matrix polymer can be poly(n-butylmethacrylate) and the hydrophobic coating polymer can be polydimethylsiloxane. In these embodiments, the mass ratio of polydimethylsiloxane to poly(n-butylmethacrylate) can be in a range from about 0.3-1 (3 g of polydimethylsiloxane and 10 grams of poly(n-butylmethacrylate) is a mass ratio of 0.3), about 0.3-0.4, about 0.4-0.5, about 0.5-0.6, about 0.6-0.7, about 0.3-0.5, about 0.6-0.8, about 0.7-0.9, about 0.8-1, about 0.3-1, about 0.6-1.2, about 1-1.4, about 1.2-1.6, about 1.4-1.8, about 1.6-2, about 1-2, about 2-3, about 3-4, about 4-5, about 2-5, about 5-6, about 6-7, about 7-8, about 8-9, about 9-10, about 2.2-2.7, about 2.3, about 2.6, about 2.4, or any mass ratio in a range bounded by any of these values.

In some embodiments, the polyalkylsiloxane, such as polydimethylsiloxane, can be about 0.1-50 wt %, about 0.1-1 wt %, about 1-2 wt %, about 2-5 wt %, about 4-7 wt %, about 6-9 wt %, about 8-11 wt %, about 10-13 wt %, about 12-15 wt %, about 14-17 wt %, about 16-19 wt %, about 18-21 wt %, about 20-23 wt %, about 10-20 wt %, about 22-25 wt %, about 24-27 wt %, about 26-29 wt %, about 28-31 wt %, about 20-30 wt %, about 0.1-30 wt %, about 30-40 wt %, about 40-50 wt %, or about 50-60 wt %, about 30-60 50 wt % , about 60-70 wt %, about 70-80 wt %, about 80-90 wt %, about 60-90 wt %, or about 90-100 wt % of the total composite, or any wt % in a range bounded by any of these values. Of particular interest are ranges that encompass one or more of the following weight percentages: about 10 wt %, about 13 wt %, about 14%, about 16 wt %, about 17 wt %, about 19 wt %, about 20 wt %, about 22 wt %, about 23 wt %, about 13 wt %, about 25 wt %, about 27 wt %, and about 30 wt %.

In some embodiments, the polycarbonate can be about 0-75 wt %, about 0.1-5 wt %, about 5-10 wt %, about 10-20 wt %, about 15-20 wt %, 20-26 wt %, 24-30 wt %, 20-25 wt %, 25-30 wt %, about 9-14 wt %, about 12-17 wt %, about 15-20 wt %, about 18-23 wt %, about 20-23 wt %, about 22-25 wt %, about 24-27 wt %, about 26-29 wt %, about 28-31 wt %, about 30-33 wt %, about 30-35 wt %, about 33-38 wt %, about 36-41 wt %, about 39-44 wt %, about 42-47 wt %, about 45-50 wt %, about 48-53 wt %, about 0.1-30 wt %, about 30-40 wt %, about 40-50 wt %, about 50-60 wt %, about 30-60 wt %, about 60-70 wt %, about 70-80 wt %, about 80-90 wt %, about 60-90 wt %, or about 90-100 wt % of the composite, or any wt % in a range bounded by any of these values. Of particular interest are ranges that encompass one or more of the following weight percentages: about 12 wt %, about 17 wt %, about 24 wt %, about 33 wt %, about 36 wt %, about 50 wt %, about 30 wt %, about 34 wt %, about 39 wt %, about 45 wt %, and about 46 wt %.

In some embodiments, the poly(n-butylmethacrylate) can be about 0-75 wt %, about 0-5 wt %, about 5-10 wt %, about 10-20 wt %, about 15-20 wt %, 20-26 wt %, 24-30 wt %, 20-25 wt %, 25-30 wt %, about 9-14 wt %, about 12-17 wt %, about 15-20 wt %, about 18-23 wt %, about 20-23 wt %, about 22-25 wt %, about 24-27 wt %, about 26-29 wt %, about 28-31 wt %, about 30-33 wt %, about 30-35 wt %, about 33-38 wt %, about 36-41 wt %, about 39-44 wt %, about 42-47 wt %, about 45-50 wt %, about 48-53 wt %, about 0.1-30 wt %, about 30-40 wt %, about 40-50 wt %, about 50-60 wt %, about 30-60 wt %, about 60-70 wt %, or about 70-75 wt % of the composite, or any wt % in a range bounded by any of these values. Of particular interest are ranges that encompass one or more of the following weight percentages: about 12 wt %, about 17 wt %, about 24 wt %, about 33 wt %, about 36 wt %, and about 50 wt %.

Microspheres

The composite can comprise a plurality of microspheres. The microspheres may be dispersed within the polymer matrix. In some cases, the microspheres protrude through the outer surface of the polymer matrix. In some embodiments, the microspheres can comprise a hybrid material. In some embodiments, the hybrid microspheres can self-assemble. In some embodiments, the microspheres can comprise a core and a coating. In some embodiments, the core comprises a core polymer. In some embodiments, the core polymer can be an acrylic polymer. In some embodiments, the core acrylic polymer comprises poly(methylmethacrylate) (PMMA). In some embodiments, the acrylic polymer can be in the form of spheres or beads. In some embodiments, the spheres or beads can have an average diameter of between 1 μm to about 100 μm.

In some embodiments, an adherent may be present on the polymer core to facilitate the attachment of the coating material to the polymer core. In some embodiments, the adherence facilitator can comprise a hydrophobic coating polymer, which may be a low surface energy polymer.

The hydrophobic coating polymer may be any suitable low surface energy polymer, such as a polyalkylsiloxane, a polydimethylsiloxane (PDMS, or a silicone, [19.8 mN/m at 20° C]), a polytrifluoroethylene (P3FEt/PTrFE, [23.9 mN/m at 20° C]), or a polytetrafluoroethylene (PTFE/Teflon™ [20 mN/m at 20° C]).

In some embodiments the hydrophobic coating polymer can comprise an organosilicon material. In some embodiments, the organosilicon material can be an alkylsilane. In some embodiments, the alkylsilane can be polydimethylsilane (polydimethylsiloxane) (PDMS). In some embodiments, the PDMS may be a suitable commercially available embodiment, for example Sylgard® 184 (DOW Corning, Midland, Mich. USA).

In some embodiments, the hydrophobic coating polymer has a surface energy of about 15-25 mN/m, about 15-16 mN/m, about 16-17 mN/m, about 17-18 mN/m, about 18-19 mN/m, about 19-20 mN/m, about 20-21 mN/m, about 21-22 mN/m, about 22-23 mN/m, about 23-24 mN/m, about 24-25 mN/m, about 15-17 mN/m, about 17-19 mN/m, about 19-21 mN/m, about 21-23 mN/m, about 23-25 mN/m, about 15-18 mN/m, about 18-21 mN/m, about 21-25 mN/m, about 15-20 mN/m, or about 20-25 mN/m.

The microsphere core may have any size associated with a spherical or ovoidal shape.

For example, a microsphere may have a size, average size, or median size such as a radius or diameter of the sphere that is about 0.1 μm to about 100 μm, about 0.1-0.5 μm, about 0.5-1 μm, about 1-10 μm, about 10-20 μm, about 20-30 μm, about 30-40 μm, about 40-50 μm, about 50-60 μm, about 60-70 μm, about 70-80 μm, about 80-90 μm, about 90-100 μm, about 30-70 μm, about 35-40 μm, about 40-45 μm, about 45-50 μm, about 50-55 μm, about 55-60 μm, about 60-65 μm, about 65-70 μm, or any size such as a radius, a diameter, in a range bounded by any of these ranges.

In some embodiments, the microsphere coating can comprise hydrophobic nanoparticles. In some embodiments, the hydrophobic nanoparticles encapsulate a portion of the circumferential surface of the core. In some embodiments the hydrophobic nanoparticles can be modified metal silicates. In some embodiments, the modified metal silicates can be a modified aluminum silicate, a modified aluminosilicate, a modified aluminum magnesium silicate, or a modified magnesium silicate. In some embodiments, the modified metal silicate can be a perfluoroalkyl modified halloysite material. In some embodiments, the hydrophobic nanoparticles do not compatibilize with the matrix polymer. In some embodiments, the nanoparticles are immiscible or insoluble within the matrix polymer. In some embodiments at least a portion of the microspheres are disposed only partially within the polymer matrix. In some embodiments the coating can comprise an adherence facilitator.

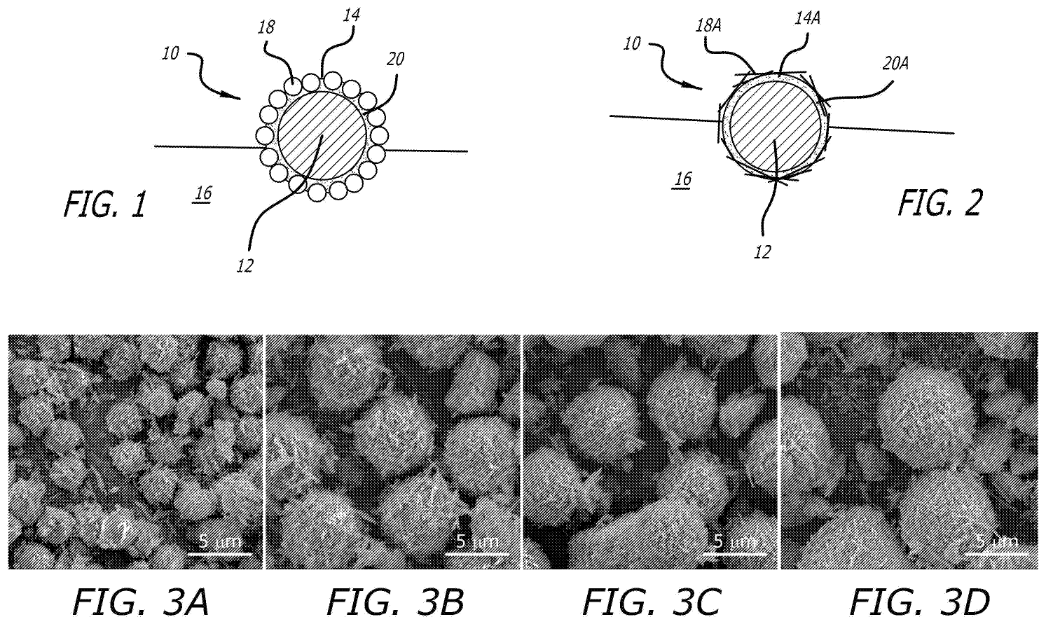

FIG. 1 is a cross section of an embodiment of a microsphere, such as microsphere 10, having a core, such as core 12 (e.g., a PMMA bead), and a coating, such as coating 14, which is embedded within a polymer matrix, such as matrix 16. The coating can comprise hydrophobic nanoparticles, such as nanoparticles 18, disposed within a hydrophobic coating polymer, or a low surface energy polymer/adherence facilitator, such as polymer 20.

FIG. 2 is a cross section of an embodiment microsphere, such as microsphere 10A, having a core, such as core 12A (e.g., a PMMA bead), and a coating, such as coating 14A, which is embedded within a polymer matrix, such as matrix 16A. The coating can comprise hydrophobic nanorods, such as nanorods 18A, disposed within a hydrophobic coating polymer, or a low surface energy polymer/adherence facilitator, such as polymer 20A.

The microspheres may have any size associated with a microsphere. For example, a microsphere may have a size, average size, or median size such as a radius or diameter of the sphere that is about 0.1 μm to about 100 μm, about 0.1-0.5 μm, about 0.5-1 μm, about 1-2 μm, about 2-3 μm, about 3-4 μm, about 4-5 μm, about 5-6 μm, about 6-7 μm, about 7-8 μm, about 8-9 μm, about 9-10 μm, about 10-12 μm, about 12-14 μm, about 14-16 μm, about 16-20 μm, about 1-10 μm, about 10-20 μm, about 20-30 μm, about 30-40 μm, about 40-50 μm, about 50-60 μm, about 60-70 μm, about 70-80 μm, about 80-90 μm, about 90-100 μm, about 30-70 μm, about 35-40 μm, about 40-45 μm, about 45-50 μm, about 50-55 μm, about 55-60 μm, about 60-65 μm, about 65-70 μm, or any size such as a radius, a diameter, in a range bounded by any of these ranges. Of particular interest are sizes that encompass one or more of the following radii or diameters: about 1 μm, about 2 μm, about 3 μm, about 4 μm, about 5 μm, about 6 μm, about 7 μm, about 8 μm, about 9 μm, and about 10 μm.

As used herein, the terms “radius” or “diameter” can be applied to microspheres that are not spherical or cylindrical. For elongated microsphere, where the aspect ratio of the ratio or length to width is important, the “radius” or “diameter” is the radius or diameter of a cylinder having the same length and volume as the microsphere. For non-elongated microspheres, the “radius” or “diameter” is the radius or diameter of a sphere having the same volume as the microsphere.

In some embodiments, the microspheres can comprise a plurality of hydrophobic nanoparticles disposed upon the core surface of the microspheres. In some embodiments, the hydrophobic nanoparticles can encapsulate a portion of the circumferential surface of the microsphere core. In some embodiments, at least some of the hydrophobic particles extend outward from the surface of the microsphere. In some embodiments, the plurality of microspheres can define cavities therebetween. In some embodiments, a portion of the hydrophobic encapsulated microspheres dispersed within the first surface of the matrix can form a micro/nano rough coating on the matrix surface.

Hydrophobic Nanoparticle

In some embodiments, the composite can comprise hydrophobic nanoparticles. In some embodiments, the hydrophobic nanoparticles can coat and encapsulate the microspheres hydrophilic core, creating a substantial hydrophobic outer surface. In some embodiments, the hydrophobic nanoparticles can comprise a modified phyllosilicate nanoclay. In some embodiments, the hydrophobic nanoparticles can comprise modified metal silicates. In some embodiments, the hydrophobic nanoparticles can comprise perfluorinated metal silicates. In some embodiments, the metal silicates can be aluminum silicate., magnesium aluminum silicate, magnesium silicate, and/or aluminosilicate. The term aluminosilicate refers to a silicate in which a proportion of the Si⁴⁺ ions are replaced by Al³⁺. Halloysite, Al₂Si₂O₅(OH)₄, is a preferred aluminosilicate. Attapulgite (or palygorskite, (Mg, Al)₂Si₄O₁₀(OH).4(H₂O), is a preferred magnesium aluminum phyllosilicate. in some embodiments, the excess negative charge may be balanced by extra sodium, potassium or calcium.

In some embodiments, the nanoparticles can be in the shape of a nanorod, a nanowire, a nanofiber, a nanotube and/or combinations thereof. Some embodiments include the hydrophobic nanoparticles as being a fluorinated phyllosilicate nanorod. In some embodiments, the nanorods can have a length of about 1 μm to about 3 μm and a width or diameter of about 30 nm to about 70 nm. It is believed that the phyllosilicate compound may have an aspect ratio (i.e., length/width or length/diameter) of about 10 to about 100, about 5-10, about 5-25, about 10-30, about 15-35, about 20-40, about 25-45, about 30-50, about 35-55, about 40-60, about 45-65, about 50-70, about 55-75, about 60-80, about 65-85, about 70-90, about 75-95, about 80-100, or any aspect ratio in a range bounded by any of these values.

In some embodiments, the modified phyllosilicate nanorod can comprise a modified aluminum silicate. In other embodiments, the modified aluminum silicate can be a halloysite nanorod, an attapulgite nanorod and/or combinations thereof. In some embodiments, the phyllosilicate nanoclay can be modified by perfluorinated compounds. For example, a polyfluoroalkyl molecule, such as trichloro(1H,1H,2H,2H-perfluorooctyl)silane can modify the surfaces of a phyllosilicate nanorod by chemical bonds so as to improve the hydrophobicity of the phyllosilicate nanorod surface. Surface modification of the phyllosilicate nanorod makes it more hydrophobic than a non-modified phyllosilicate nanorod. The reaction is represented below:

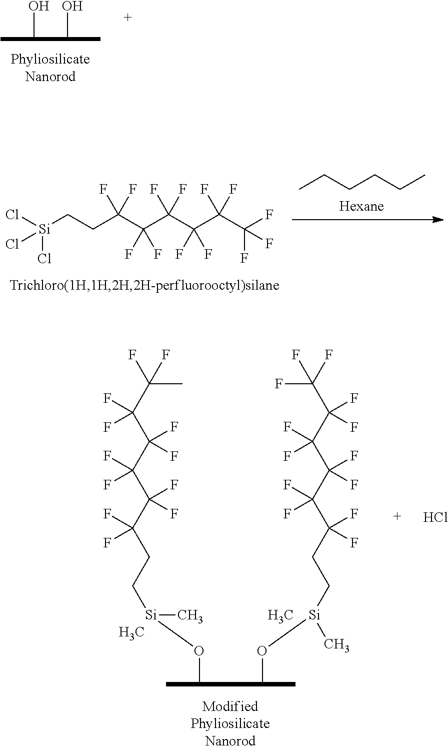

In some embodiments, the modified phyllosilicate nanorods can be about 15-70 wt %, about 15-20 wt %, about 20-30 wt %, about 30-40 wt %, about 40-50 wt %, about 50-60 wt %, about 60-70 wt %, about 40-45 wt %, about 45-50 wt %, about 50-55 wt %, about 55-60 wt %, about 43-45 wt % about 49-51 wt %, or about 53-55 wt % of the total weight of the composite, or any weight percentage in a range bounded by any of these values. Of particular interest are any of the above ranges that encompass one or more of the following weight percentages: about 29 wt %, about 32 wt %, about 36 wt %, about 38 wt %, about 40 wt %, about 43 wt %, about 44 wt %, about 47 wt %, about 48 wt %, about 53 wt %, about 54 wt %, about 60 wt %, and about 66 wt %.

In some embodiments, the silica nanoparticles can be modified, e.g. chemically modified. For example, the organosiloxane compound can modify the surfaces of the silica nanoparticle by chemical bonds (such as chemical bonds generated by hydrolysis) so as to improve the hydrophobicity of the surfaces of the silica nanoparticles. In other embodiments, the modified silica nanoparticles can be commercial products such as Silicon Oxide Nanoparticles/Nanopowder treated with Silane Coupling Agents SiO₂ 99% (SkySpring Nanomaterials, Inc. Houston Tex., USA).

In some embodiments, the silica nanoparticle to have its surface modified may be any nanoparticle that comprises silica or silicon dioxide, such as a SiO₂ particle, e.g. a sphere. Prior to modification, the nanoparticles may be essentially pure silica nanoparticles, or may contain at least about 0.1 wt %, at least about 10 wt %, at least about 20 wt %, at least about 30 wt %, at least about 40 wt %, at least about 50 wt %, at least about 60 wt %, at least about 70 wt %, at least about 80 wt %, at least about 90, about 0.1-10 wt %, about 10-20 wt %, about 20-30 wt %, about 30-40 wt %, about 40-50 wt %, about 50-60 wt %, about 60-70 wt %, about 70-80 wt %, about 80-90 wt %, or about 90-100 wt % silicon dioxide or silica.

A hydrophobic silica nanoparticle may have any size associated with a nanoparticle. For example, a hydrophobic silica nanoparticle may have a size, average size, or median size, such as a radius or a diameter, of the particle that is about 10-500 nm, about 20 nm, about 10-20 nm, about 10-30 nm, about 20-30 nm, about 30-40 nm, about 40-50 nm, about 50-60 nm, about 60-70 nm, about 70-80 nm, about 80-90 nm, about 90-100 nm, about 10-100 nm, about 100-110 nm, about 100-200 nm, about 150-250 nm, about 200-300 nm, about 250-350 nm, about 300-400 nm, about 350-450 nm, about 400-500 nm, or any size, such as a radius or a diameter, in a range bounded by any of these values.

Any suitable amount of the modified silica nanoparticle may be used. In some embodiments, the silica nanoparticle may (e.g. SiO2 nanoparticles) be about 1-10 wt %, about 10-20 wt %, about 20-30 wt %, about 30-40 wt %, about 40-50 wt %, about 50-60 wt %, about 60-70 wt %, about 70-80 wt %, about 80-90 wt %, or about 90-100 wt %, of the composite, or any weight percentage in a range bounded by any of these values.

The silica nanoparticles can be fabricated by sol-gel method, vapor reaction method, hydro-thermal method, deposition method, physical crumbling method mechanical ball polishing method, chemical vapor deposition method, micro-emulsion method, electro-chemistry method, or any method known in the art.

Micro/Nano Rough Surface

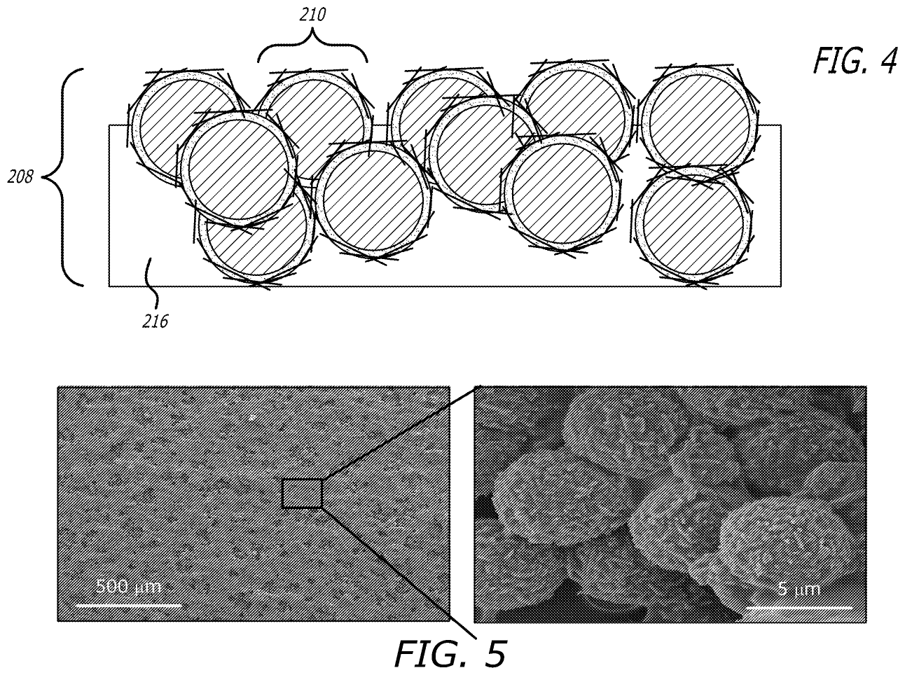

FIG. 4 shows a coating, such as coating 208, comprising a plurality of microspheres, such as microspheres 210, disposed within, embedded within and/or disposed upon a polymer matrix, such as polymer matrix 216. In some embodiments, the polymer matrix comprises a high surface energy polymer or first matrix polymer. In some embodiments, the polymer matrix comprises the high surface energy or first matrix polymer and/or the low surface energy or second matrix polymer that can be combined or mixed to form a the polymer matrix. In some embodiments, a substantial amount of the hydrophobic nanoparticle encapsulated microspheres, can be dispersed within the polymer matrix. In some embodiments, a sufficient amount of the hydrophobic nanoparticle encapsulated microspheres can partially protrude through the outer surface of the matrix creating a micro/nano roughness thereon. In some embodiments, at least some of the hydrophobic nanoparticles can extend outward from the surface of the microsphere. In some embodiments, the nanoparticles can extent radially outward and/or non-tangentially outward. The composite can also contain other components, such as particle additives. In some embodiments, the composite can comprise hydrophobic nanoparticle encapsulated microspheres dispersed throughout the matrix, including the surface thereof, e.g., a bulk suprehydrophobic material/composite.

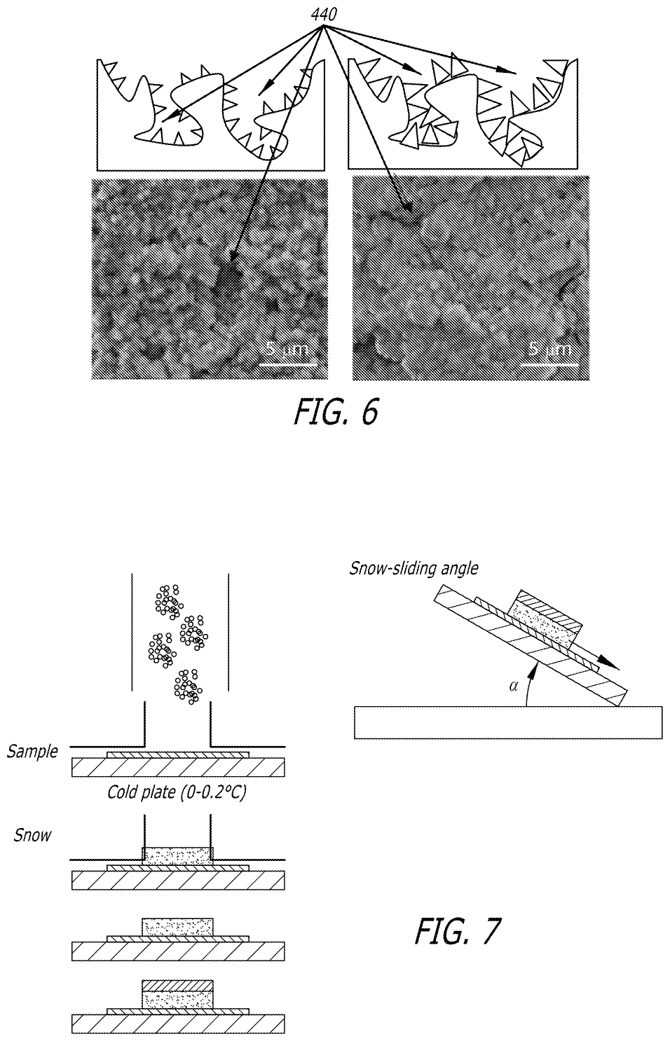

In some embodiments, hydrophobic nanoparticle encapsulated microspheres can have a substantially uniform distribution within the composite. The distribution of hydrophobic nanoparticle encapsulated microspheres in turn is thought to result in a coating having exposed surfaces that define a micro/nano roughness commensurate with the dimensions of the microspheres and the nanorods. In some embodiments, the plurality of microspheres may define cavities therebetween. It is further thought the microspheres distribution creates defined cavities, such as cavities 440, in FIG. 6, between and among the plurality of hydrophobic nanoparticle microspheres that protrude through the first surface of the polymer matrix. It is further believed that these defined cavities are, to a substantial extent, reduced in size due to the nanorods' ability to reinforce the coating's polymeric matrix through their networking with one another. The presence of the nanorods is believed to result in reduced cracking in the coating during curing. It is further believed that the reduction in the size of the defined cavities results in a crack free surface, which in turn results in significant improvements in the composites' snow sliding performance. It is believed that decreasing the area of the defined cavities and thus the cracks within the surface of the coating, increases dry snow sliding while still maintaining the overall water contact angle of the coating. This increase in dry snow sliding from the coating is a significant improvement over currently available anti-snow/anti-icing coatings. This increase in the dry snow sliding is believed to be due to dry snows inability to accumulate within the air gaps/pockets or surface cracks. Unlike wet or heavy snow, dry snow has a very low water content, which results in dry snow's inability to form a water layer between the coating composite surface and the snow. The lack of a water layer thus allows the dry snow to accumulate within the large defined cavities and/or cracks on the composites' surface, which is minimized in the current disclosure by the presence of the nanorods.

The micro roughness may have any size associated with a microsphere and/or the cavities in between microspheres. The microsphere can comprise any suitable material, for example but not limited to, self-assembled microspheres with a hydrophobic core, silica beads, etc. The microsphere may have a size, average size, or median size such as a radius or a diameter, of the particle that is about 1 μm to about 10 μm, about 1-2 μm, about 2-3 μm, about 3-4 μm, about 4-5 μm, about 5-6 μm, about 6-7 μm, about 7-8 μm, about 8-9 μm, about 9-10 μm, about 2.5-5.5 μm, about 7.5-10 μm, or any size, such as a radius, a diameter, in a range bounded by any of these values.

The nano roughness may have any size associated with a nanoparticle and/or the spaces between nanoparticles. The nanoparticle can comprise any suitable materials, for example but not limited to a nanorod, nanowire, nanotube, nanofiber, etc. The nanoparticle may have a size, average size, or median size such as a radius or diameter, of the particle that is about 10 nm to about 500 nm, about 10-20 nm, about 10-30 nm, about 20-30 nm, about 30-40 nm, about 40-50 nm, about 50-60 nm, about 60-70 nm, about 70-80 nm, about 80-90 nm, about 90-100 nm, about 10-100 nm, about 100-110 nm, about 100-200 nm, about 150-250 nm, about 200-300 nm, about 250-350 nm, about 300-400 nm, about 350-450 nm, about 400-500 nm, or any size, such as a radius, a diameter, in a range bounded by any of these values.

Some embodiments include a method of making a coating. The method can comprise the steps of: mixing an amount of a first matrix polymer, optionally a second matrix polymer, and a solvent to create a first solution. In some embodiments, the preformed and surface modified microspheres are added to the first solution. In some embodiments, the resulting mixture can be stirred for an amount of time creating a final slurry.

In some embodiments, an amount of ceramic milling media can be added to the final slurry. In some examples, the final solution/slurry with ceramic milling media can be transferred to a ball milling machine mixing at 160 rpm for at least sixteen (16) hours, creating a coating slurry. In some embodiments the slurry is coated onto a substrate in need thereof.

Surface Applications of the Composites

In some embodiments, a method of surface treatment can comprise applying the aforedescribed composite to a surface in need thereof.

Some embodiments include a method of coating by air brush. In some embodiments, a slurry for spray coating can be prepared by dissolving polymer binders in a solvent. In some embodiments the slurry can be prepared by mixing the microsphere preform with a solution of the matrix polymer. In some embodiments, a single matrix polymer can be used. In some embodiments, the matrix polymer can have a high free surface energy. In some embodiments, the matrix polymer can be a polycarbonate or a poly(n-butylmethacrylate). In some embodiments, plural matrix polymers can be used. In some embodiments, the plural matrix polymers can be at least one high surface energy material, e.g., polycarbonate, and at least one low surface energy material, e.g., PDMS.

In some embodiments, the slurry comprising microsphere, matrix polymer and solvents can be sprayed onto a substrate by air brush, in which an airbrush can work by passing a stream of fast moving (compressed) air through a venturi, which creates a local reduction in air pressure (suction) that allows paint to be pulled from an interconnected reservoir at normal atmospheric pressure.

In some embodiments, a composite may be in the form of a solid layer on a surface where prevention of anti-fouling, ice and/or snow accumulation is required. In some embodiments, the composite is a solid layer with a thickness of about 16-20 μm, about 18-22 μm, about 20-24 μm, about 22-26 μm, about 24-28 μm, about 26-30 μm, about 28-32 μm, about 30-34 μm, about 32-36 μm, about 34-38 μm, about 36-40 μm, about 38-42 μm, about 40-44 μm, about 42-46 μm, about 44-48 μm, about 46-50 μm, about 45-52 μm, about 50-57 μm, about 55-62 μm, about 60-67 μm, about 65-72 μm, about 70-77 μm, about 75-82 μm, about 80-87 μm, about 85-92 μm, about 90-97 μm, about 95-102 μm, about 100-107 μm, about 105-112 μm, about 110-117 μm, about 115-122 μm, about 120-127 μm, or about 125-132 μm, or any thickness in a range bounded by any of these values. Of particular interest are any of the above ranges that encompass one or more of the following thicknesses: about 22 μm, about 23 μm, about 27 μm, about 30 μm, about 33 μm, about 35 μm, about 46 μm, about 79 μm, and about 106 μm.

In some embodiments, a composite may be used in a surface treatment for repelling ice, water, or snow from a surface. The method can comprise treating a surface with a mixture comprising at least one high surface free energy first matrix polymer (e.g., polycarbonate) at least one surface free energy or second matrix polymer, e.g., polydimethylsiloxane, hydrophobic nanoparticles (e.g., fluorinated aluminum silicate nanoparticle), and/or preformed acrylic microspheres (e.g., a PMMA preformed bead).

For treating a surface, composite may be mixed in a solvent to form a coating mixture. Such a mixture can comprise the requisite amounts of matrix polymer(s), microparticle hydrophobic nanoparticle and a solvent, such as toluene, tetrachloroethane, acetone or any combination thereof. In some embodiments, the treatment comprises: (1) mixing hydrophobic polymer(s), hydrophobic microparticles, and hydrophobic nanoparticle with a solvent to form a coating, (2) applying the mixture on the untreated surface, and (3) curing the coating by heating the coating to a temperature between 80° C. to about 120° C. for 3 hours to about 24 hours, to completely evaporate the solvent.

In some embodiments, the step of treating can also comprise the intermediate steps of drying, crushing, and reconstituting the mixture after mixing but before applying the mixture. It is believed that the intermediate steps will ensure uniform mixing and prevent lumps in the coating. In some the intermediate steps, where the mixture is first suspended in a solvent, the solvent can be evaporated by methods known to those skilled in the art to create a dried powder. In some methods, then the dried powder can be subsequently crushed by methods known in the art, such as a mortar and pestle, to break up any lumps. In some crushing steps, a solvent, such as acetone, may be added to help break up lumps and facilitate a smooth mixture. In some methods the intermediate step of crushing and drying can then comprise drying the smooth mixture at a temperature of about 40° C. to about 100° C., or about 90° C., until completely dry.

In some embodiments the treating step can also comprise applying the coating mixture on the untreated surface. Applying the coating mixture can be done by any methods known by those skilled in the art, such as blade coating, spin coating, dye coating, physical vapor deposition, chemical vapor deposition, spray coating, ink jet coating, roller coating, etc. In some embodiments, the coating step can be repeated until the desired thickness of coating is achieved. In some methods, applying can be done such that a contiguous layer is formed on the surface to be protected.

In some embodiments, the wet coating of composite may have a thickness of about 1-50 μm, about 10-30 μm, about 20-30 μm, about 50-150 μm, about 100-200 μm, about 150-250 μm, about 200-300 μm, about 260-310 μm, about 280-330 μm, about 300-350 μm, about 320-370 μm, about 340-390 μm, about 360-410 μm, about 380-430 μm, about 400-450 μm, about 420-470 μm, about 400-600 μm, about 500-700 μm, or about 600-800 μm or any thickness in a range bounded by any of these values. Of particular interest are any of the above ranges that encompass one or more of the following thicknesses: about 25 μm, about 300 μm, about 350 μm, about 380 μm, and about 790 μm.

In some embodiments, treating can further comprise curing the coating by heating the coating to a temperature and time sufficient to completely evaporate the solvent. In some embodiments, the step of curing can be done at a temperature of about 40° C. to about 150° C., or about 120° C., for about 30 minutes to 3 hours, or about 1-2 hours, until the solvent is completely evaporated. In some embodiments, a composition by the process described above can be provided. The result can be a treated surface that can be resistant to water or ice even after facing a harsh environment where some of the coating has been eroded.

### Embodiments

Embodiment 1 A composite comprising

a. A polymer matrix, having a first surface, the matrix comprising a first hydrophobic polymer and a second hydrophobic polymer , the first hydrophobic polymer having a greater surface free energy than the second hydrophobic polymer; and

b. A plurality of microspheres, the microspheres dispersed upon the surface of the polymer matrix, the microspheres comprising a core comprising an acrylic polymer, and a hydrophobic coating surrounding the core, the coating comprising a plurality of hydrophobic nanoparticles and the second hydrophobic polymer.

Embodiment 2 The composite of embodiment 1, wherein the hydrophobic nanoparticles encapsulate a portion of the circumferential surface of the core.

Embodiment 3 The composite of embodiment 1, wherein at least some of the hydrophobic particles extend outward from the surface of the microsphere.

Embodiment 4 The composite of embodiment 1, wherein the plurality of microspheres define cavities therebetween.

Embodiment 5 The composite of embodiment 1, wherein the hydrophobic nanoparticles are metal silicates.

Embodiment 6 The composite of embodiment 5, wherein the metal silicates are aluminum silicate, aluminosilicate, aluminum magnesium silicate, or magnesium silicate.

Embodiment 7 The composite of embodiment 5, wherein the metal silicate is perfluoroalkyl modified halloysite materials.

Embodiment 8 The composite of embodiment 1, wherein the hydrophobic nanoparticles comprise hydrophobized hydrophilic materials.

Embodiment 9 The composite of embodiment 1, wherein the hydrophobized materials comprise a perfluoroalkyl modified halloysite.

Embodiment 10 The composite of embodiment 1, wherein hydrophobic nanoparticles do not compatibilize with the first hydrophobic polymer and at least a portion of the microspheres are disposed only partially within the matrix.

Embodiment 11 The composite of embodiment 1, wherein the composite is a coating.

Embodiment 12 The composite of embodiment 12, wherein the first hydrophobic polymer has a surface energy of at least 30 γₛ/mJ m⁻².

Embodiment 13 The composite of embodiment 12, wherein the second hydrophobic polymer has a surface energy of up to 20 γₛ/mJ m⁻².

Embodiment 14 The composite of embodiments 1, wherein the first hydrophobic polymer comprises a thermoplastic polymer.

Embodiment 15 The composite of embodiments 1, wherein the thermoplastic polymer is polycarbonate.

Embodiment 16 The composite of embodiment 1, wherein the second hydrophobic polymer is an alkylsilane.

Embodiment 17 The composite of embodiment 16, wherein the second hydrophobic polymer comprises a polysiloxane.

Embodiment 18 The composite of embodiment 1, wherein the polysiloxane comprises polydimethylsiloxane.

Embodiment 19 The composite of embodiment 12, wherein the polymer matrix comprises a combination of polycarbonate and polydimethylsiloxane.

Embodiment 20 The composite of embodiment 1, wherein the acrylic cores have a radius or a diameter of about 1 μm to about 100 μm.

Embodiment 21 The composite of embodiment 17, wherein the phyllosilicate nanoclay is an aluminum silicate, a magnesium aluminum silicate and/or combinations thereof.

Embodiment 22 The composite of embodiments 1, wherein the nanoparticles are a nanorod, a nanowire, a nanofiber, a nanotube and/or combinations thereof.

Embodiment 23 The composite of embodiment 23, wherein the nanoparticles are a nanorod.

Embodiment 24 The composite of embodiment 23, wherein the nanorod has a length of about 1 μm to about 3 μm and a radius/diameter of about 10 nm to about 100 nm.

Embodiment 25 The composite of embodiment 1-24, wherein the protruding microspheres provide composite surface micro roughness of about 0.1 μm to about 50 μm.

Embodiment 26 The composite of embodiment 1-25, wherein the hydrophobic nanoparticles within the coating provide a nano roughness of about 10 nm to about 500 nm.

### EXAMPLES

It has been discovered that embodiments of the composite described herein exhibit bulk performance. These benefits are further demonstrated by the following examples, which are intended to be illustrative of the disclosure, but are not intended to limit the scope or underlying principles in any way.

### Example 1.1

### Preparation of the Hydrophobic Nanorods

In a 500 mL two-neck round bottom glass flask, 100 g hexanes (98%, VWR international) and 1.12 g trichloro(1H,1H,2H,2H,-perfluorooctyl)silane (Sigma-Aldrich, assay 97%) were combined. The mixture was kept stirring with a Teflon stirring bar for 15 min, then 11.24 g halloysite nanoclay powder (Al₂Si₂O₅(OH)₄), diameter length: 30-70 nm×1-3 μm, pore size: 1.26-1.34 mL/g pore volume; surface area: 64 m²/g) (Millipore-Sigma), was subsequently added to form a slurry. Anti-mouth rubber stoppers were plugged in the flask mouths to keep out moisture. In some cases, the flask can be purged with dry nitrogen or argon gas to reduce the moisture residue in the flask. In some cases, the halloysite powder can be pre-heated at 100° C. for 2 hr to remove the water absorbed during storage. The slurry was vigorously stirred for about 20 hr at room temperature.

The reaction product was transferred to 50 mL plastic centrifuge tubes and then centrifuged to separate the liquid phase and solid phase with centrifuge machine at 2500 rpm for 3 min (ICE Centra CL2, Thermo Electron Corp, USA). The separated solid phase was rinsed further by adding hexanes and repeating the centrifuge process for at least three times to remove the un-reacted perfluoroalkyl starting material. In some cases, vortex mixing or sonication bath was used in the second and following rinse before centrifuge. The obtained precipitate in centrifuge was dried in oven at 70° C. for at least 5 hr to remove the solvent completely.

### Example 1.2

### Preparation of Microsphere Preform Powder With Nanoscale Surface Roughness

To make binder solution, in 20 mL glass vial, 1.0 g silicone elastomer base and 0.1 g of curing agent (Sylgard° 184 Dow Corning Inc. USA) and toluene were added. The mixture was mixed with a planetary centrifugal mixer (THINKY AR-100, THINKY USA) at 2000 rpm for 1 min to obtain solution (A). A diluted silicone elastomer solution (B) was obtained by adding 1 g of solution (A) and 10 g toluene in a 20 mL glass vial and then mixed at 2000 rpm for 1 min with THINKY mixer. Microsphere preforms with nano scale surface roughness were obtained by mixing cross-linked PMMA microsphere of 2 μm, 4 μm, 6 μm, and 8 μm in average particle size (SSX-106, Sekisui Chemical, JAPAN), fluorinated halloysite nanorod (from Example 1.1) and silicone elastomer solution (B) at weight ratio (PMMA microsphere (SSX-106): 0.5 g; silicone elastomer solution (B): 4 mL;—fluorinated halloysite: 2.0 g). An acoustic mixer (LabRAM Resonant Acoustic Mixer, Resodyne Inc., USA) was used to mix the ingredients above at resonant intensity of 30%, acceleration of 35G's and duration of 10 min. The volume ratio of the fluorinated halloysite nanorods to PMMA beads was adjusted to the range of 1 to 3 (see Table). The obtained mixture was cured in ambient atmosphere at 100° C. for 16 hr in a convection oven (Symphony™, VWR International). The cured microsphere preform powder was passed through a sieve of 200 mesh (opening 0.074 mm) to remove the agglomerated particles. The obtained microsphere preforms powder was shown to be hydrophobic by mixing the 0.1 g powder with 20 mL water in a 50 mL glass beaker and stirring with glass rod. The powder persistently floated on water, indicating the microsphere preforms had a hydrophobic or a superhydrophobic surface. The resulting microspheres are shown in FIG. 3A (2 μm PMMA preformed bead core), FIG. 3B (4 μm PMMA preformed bead core), FIG. 3C (6 μm PMMA preformed bead core), and FIG. 3D (8 μm PMMA preformed bead core).

TABLE
Formulation of microsphere preform comprising
fluorinated halloysite and PMMA beads

| PMMA | F-HS | PMMA | PDMS | Curing | |
|---|---|---|---|---|---|
| size(μm) | (g) | beads (g) | (g) | agent(g) | Toluene(g) |
| 4 | 3.0 | 1.0 | 0.60 | 0.06 | 6.4 |
| 4 | 2.2 | 1.0 | 0.60 | 0.06 | 6.4 |
| 4 | 4.3 | 1.0 | 0.60 | 0.06 | 6.4 |
| 4 | 6.5 | 1.0 | 0.60 | 0.06 | 6.4 |

(F-HS: fluorinated halloysite; PDMS: polydimetylsiloxane)

### Example 2

### Preparation of Coating Mixture

### Preparation of Coating Slurry:

A slurry coating mixture was prepared by combining 1.0 g microsphere preform powder, 0.2 g silicone elastomer (Sylgard 184. Dow Corning), and 0.75 g of 20 wt % polycarbonate solution in toluene.

Coating Application—Method 1:

A hydrophobic coating was obtained by casting the slurry with square doctor blade applicator (Paul N. Gardner Co.) with fix gap of 5 mil on PET substrate of 75 micrometer in thickness with automatic coating machine (AFA-II, MTI Corp.). The vacuum plate to hold the PET substrate was pre-heated to 40° C. to increase the solvent evaporation rate. The cast coating was further dried in a forced air oven (Symphony™, VWR) at 100° C. for 1 hr. The obtained coating has a thickness in the range of 10 to 50 micrometer.

Coating Application—method 2. The slurry was cast on a PET film (7.5 cm×30 cm) with a Casting Knife Film applicator (Microm II Film Applicator, Paul N. Gardner Company, Inc.) at a cast rate of 10 cm/s. The blade gap on the film applicator was set at about 5 mils for a final wet coating thickness of about 127 μm. For applications wider than about 2 inches/5.1 cm, an adjustable film applicator (AP-B5351, Paul N. Gardner Company, Inc., Pompano Beach, Fla., USA) was alternatively used.

The PET was pre-heated to about 40° C. on the vacuum bed of the compact tape casting coater (MSK-AFA-III, MTI Corporation, Richmond, Calif., USA) to increase the solvent evaporation rate. The coating was then dried for 1 hour at 100° C. inside an air-circulating oven (105 L Symphony Gravity Convection Oven, VWR) until completely dry, to produce the treated substrate.

### Example 3

### Preparation of Superhydrophobic Spray Coating

Slurry Preparation. A slurry for spray coating was prepared by mixing the microsphere preform (comprising PMMA polymer bead cores and fluoroalkyl modified halloysite coatings), polycarbonate or poly(butylmethacrylate) as a binder, optionally PDMS as an additional binder, and toluene or isopropanol (IPA) as solvent, in the amounts set forth in Table 2 below. Total solid content (including microsphere preform and polymer binders) accounted for 10 wt % of the total weight of the coating formulation. The weight ratio of the microsphere preform to polymer binders was 1 part to 0.2-1.0 part. In the examples where two binders (polycarbonate and PDMS, samples S-7 to S-9) were used, the weight ratio of the polycarbonate to PDMS was about 1 part to about 0.4 parts. Table 2 shows the spray coating formulations.

TABLE 2
Table Formulation of spray coatings comprising
microsphere preform and polymer binders

| | Microspher | Binder | Binder | Solvent |
|---|---|---|---|---|
| Sample | perform (g) | (g) | (g) | (g) |
| S-1 | 1.0 | (PnM) 0.2 | — | (IPA) 10.8 |
| S-2 | 1.0 | (PnM) 0.5 | — | (IPA) 13.5 |
| S-3 | 1.0 | (PnM) 1.0 | — | (IPA) 18.0 |
| S-4 | 1.0 | (PC) 0.2 | — | (Toluene) 10.8 |
| S-5 | 1.0 | (PC) 0.5 | — | (Toluene) 13.5 |
| S-6 | 1.0 | (PC) 1.0 | — | (Toluene) 18.0 |
| S-7 | 1.0 | (PC) 0.14 | (PDMS) 0.06 | (Toluene) 10.8 |
| S-8 | 1.0 | (PC) 0.36 | (PDMS) 0.14 | (Toluene) 13.5 |
| S-9 | 1.0 | (PC) 0.71 | (PDMS) 0.29 | (Toluene) 18.0 |

PnM: poly(n-butyl methacrylate);
IPA: Isopropanol;
PC: polycarbonate;
PDMS: polydimethylsiloxane)

Spray Coating. The slurry was sprayed onto PET substrate perpendicularly at a distance from about 20 cm to 30 cm with an airbrush (Master Airbrush, TCP Global, USA) at air pressure about 50-60 psi. The coating was dried at 100° C. under ambient atmospheric conditions for 1 hour to evaporate the solvent completely.

### Example 3.1

### Performance Testing of Selected Elements

Preparation of Ice Powder: Ice blocks (−30° C. to −20° C.) were shaved with a shaved ice maker (Doshisha Model DCSP-1751 Ice Shaver, Doshisha Corporation Ltd., Tokyo, Japan) in a chest freezer (Kelvinator Commercial Chest Freezer Model KCCF160QWA, Electrolux Professional Inc., Charlotte, N.C., USA). The shaved ice was then passed through an 8-inch sieve (#18 VWR® 8″ Test Sieve, VWR International, L.L.C., Radnor, Pa., USA)) with a 1 mm opening. The resulting ice powder was stored in the chest freezer until use.

Snow Fall Test: Sample plates (11.5 cm width×14 cm length) will be coated with a test coating (coating area: 10 cm width×14 cm length) and taped in place on a cold plate heat sink (Ohmite Model CP4A-114A-108E, Ohmite Holding, L.L.C./Warrenville, Ill., USA). The cold plate heat sink will be in turn mounted on an adjustable angle mount (Thorlabs Model AP 180, Thorlabs Company, Newton N.J., USA) to form a test cell with the cold plate heat sink's temperature controlled by a chiller (Coherent Model T255P, Coherent, Inc. Santa Clara, Calif., USA), with the temperature being slightly above 0° C. (e.g., 0.2° C.). The test cell will be placed in a freezer/refrigerator (Excellence Industries model HB-6HCD, Excellence Industries, Tampa Fla., USA), and all experiments will be carried out within the freezer/refrigerator, with the sample temperature about 0° C.±1° C.

The ice powder will fall through a duct with a diameter of about 7.5 cm Water content of the fallen ice powder will be controlled by the amount of duct that exposed above the freezer/refrigerator, exposing the ice powder to ambient room temperature for a portion of its free fall (ambient temperature is about 20° C.). Specifically, for this experiment water content of the ice powder will be held to 10 wt %. With the test cell placed immediately below the duct, the incline angle will be adjusted to either 60°, 45° or 30°. The ice powder will be then taken from the freezer/refrigerator and will be dumped from the top of the duct using a sieve for the sifter. Since the diameter of the duct will be smaller (7.5 cm) than the total area of the sample plates width (11.5 cm), the ice powder will be dumped only onto the coated portion of the sample plate, avoiding strong ice powder adhesion to non-coated areas of the sample plate. The bottom of the sample will also be slightly rolled to the backside of the cold plate to prevent ice powder accumulation at the coating edge. Snow accretion or sliding from the sample coating will then be recorded by a digital video camera. The data will be evaluated and scaled, the scaled evaluation of the snow accumulation will be based on the average weight or area covered by the frequency (time) of snow accumulation at the respective test angles. In some embodiments, the composite provides a snow fall test score of 5 or better. A score of 5 is equivalent to no snow adhesion, snow keeps sliding off the test area. In some embodiments, the composite provides a snow fall test score of 4 or better. A score of 4 is equivalent to snow crystals adhering to the surface but sliding off the surface after about every 10 seconds of accumulation with an average coverage area of about 20%. In some embodiments, the composite provides a snow fall test score of 3 or better. A score of 3 is equivalent to snow crystals adhering to the surface with snow sliding off after about every 30 seconds to 1 minute of accumulation. In some embodiments, the composite provides a snow fall test score of 2 or better. A score of 2 is equivalent to the average snow accumulation on more than 80% of the test area with snow sliding after every 3-5 minutes of accumulation. In some embodiments, the composite provides a snow fall test score of 2 or better. A score of 1 indicates that the snow does not slide off the test surface. Results for different coatings appear in Table 3 below.

Snow Sliding Angle Testing: Samples will be secured into place on the test cell as previously described. A mask with a 2.5 cm diameter opening will be placed on top of the sample in the test cell. The masked area of the test sample will be partially filled in (approximately 1-3 mm, about 0.05 to about 0.1 g) using the sieve to make an ice powder pellet. The mask will be carefully removed and a metal plate (copper or aluminum) with a 2.5 cm diameter and of differing weight (0.67 g to 10 g) will be placed on top of the ice powder pellet. To measure the incline angle of the test cell, a digital bevel box gauge angle protractor (Gain Express model AG-0200BB, Gain Express Holdings, Ltd., Kowloon, Hong Kong) will be placed on the test cell to measure the incline angle. The incline angle of the test cell will then be gradually increased manually until the metal plate covered ice pellet started to slide, see FIG. 7 for a representation of the test. The value will be recorded as the sliding angle at the weight (a[deg]). The sliding angle vs. weight (weight of the metal plate) will be fitted using the following formula:

$$sin α - {μ}_{s} cos α \frac{{f}_{0}}{mg} = S ,$$

where μₛ=static friction coefficient between the ice powder pellet and the sample surface [-], f₀=shear adhesion strength between the ice pellet and the sample surface [Nm⁻²], m=mass of the metal plate [kg], g=gravity [ms²], and S=the nominal area of contact between the ice powder pellet and the sample surface [m²]. The results are presented in Table 3.

TABLE 3

| | Snow Sliding Angle | | Snow Fall Test | | |
|---|---|---|---|---|---|
| Composite | μ₂ | f₀ | 60° | 45° | 30° |
| GP-1 | | | | | |
| CE-1 (HIREC 100) | 1.57 | 0.12 | 4.5-5.0 | 1 | 0 |

The results show that the embodiments have anti-snow activity at 60° and 45°.

Unless otherwise indicated, all numbers expressing quantities of ingredients, properties such as molecular weight, reaction conditions, and etc. used herein are to be understood as being modified in all instances by the term “about.” Each numerical parameter should at least be construed in light of the number of reported significant digits and by applying ordinary rounding techniques. Accordingly, unless indicated to the contrary, the numerical parameters may be modified according to the desired properties sough to be achieved, and should, therefore, be considered as part of the disclosure. At the very least, the examples shown herein are for illustration only, not as an attempt to limit the scope of the disclosure.

The terms “a,” “an,” “the,” and similar referents used in the contest of the describing embodiments of the present disclosure (especially in the context of the following claims) are to be construed to cover both the singular and the plural, unless otherwise indicated herein or clearly contradicted by context. All methods described herein may be performed in any suitable order unless otherwise indicated herein or otherwise clearly contradicted by context. The use of any and all examples, or exemplary language (e.g., “such as”) provided herein is intended merely to better illustrate embodiments of the present disclosure and does not pose a limitation on the scope of any embodiment. No language in the specification should be construed as indicating any non-embodied elements essential to the practice of the embodiments, of the present disclosure.

Groupings of alternative elements or embodiments disclosed herein are not to be construed as limitations. Each group member may be referred to and embodied individually or in any combination with other members of the group or other elements found herein. It is anticipated that one or more members of a group may be included in, or deleted from, a group for reasons of convenience and/or patentability.

Certain embodiments are described herein, including the best mode known to the inventors for carrying out the embodiments. Of course, variation on these described embodiments will become apparent to those of ordinary skill in the art upon reading the foregoing description. The inventor expects skilled artisans to employ such variations as appropriate, and the inventors intend for the embodiments of the present disclosure to be practiced otherwise than specifically described herein. Accordingly, the embodiments include all modifications and equivalents of the subject matter recited in the embodiments as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the embodiments. Other modifications that may be employed are within the scope of the embodiments. Thus, by way of example, but not of limitation, alternative embodiments may be utilized in accordance with the teachings herein. Accordingly, the embodiments are not limited to embodiments precisely as shown and described.

1. A hydrophobic composite, comprising:
a polymer matrix, comprising a first matrix polymer, wherein the first matrix polymer has a surface energy of at least 30 mJ/m²;
a plurality of microspheres, comprising a core and a hydrophobic coating surrounding the circumference of the core, wherein:
the microsphere core comprises an acrylic polymer; and
the microsphere coating comprises hydrophobic nanoparticles.

2. The hydrophobic composite of claim 1, wherein the polymer matrix further comprises a second matrix polymer having a surface energy of about 22 mJ/m² or less.

3. The hydrophobic composite of claim 1, wherein the first matrix polymer comprises polycarbonate.

4. The hydrophobic composite of claim 1, wherein the first matrix polymer comprises poly(n-butylmethacrylate).

5. The hydrophobic composite of claim 2, wherein the second matrix polymer comprises poly(dimethylsiloxane) [PDMS].

6. The hydrophobic composite of claim 1, wherein the acrylic polymer comprises poly(methylmethacrylate) [PMMA].

7. The hydrophobic composite of claim 1, wherein the acrylic polymer is a PMMA bead that has a diameter of about 1 μm to about 100 μm.

8. The hydrophobic composite of claim 1, wherein the hydrophobic nanoparticles comprise a modified phyllosilicate nanoclay.

9. The hydrophobic composite of claim 1, wherein the hydrophobic nanoparticles comprise perfluorinated halloysite.

10. The hydrophobic composite of claim 1, wherein the hydrophobic nanoparticles comprises a nanorod, a nanowire, a nanofiber, a nanotube, or any combination thereof.

11. The hydrophobic composite of claim 1, wherein the hydrophobic nanoparticles extend outward from the core of the microspheres.

12. The hydrophobic composite of claim 1, wherein the microspheres have a diameter of about 1 μm to about 100 μm.

13. The hydrophobic composite of claim 1, wherein the microspheres provide a surface micro roughness of about 0.1 μm to about 50 μm.

14. The hydrophobic composite of claim 1, wherein the microspheres provide a nano roughness of about 10 nm to about 500 nm.

15. A coating comprising the hydrophobic composite of claim 1, wherein the coating is superhydrophobic or snowphobic.

16. A method for preparing the coating of claim 15 for a casting application, comprising:
mixing an amount of a matrix polymer and a solvent to create a solution;
adding surface modified microspheres and mixing to form a slurry;
casting the slurry upon a substrate; and
drying the coated substrate at a temperature of about 100° C. for about 1 h.

17. A method for preparing the coating of claim 15 for a spray coating application, comprising:
mixing an amount of a matrix polymer and a solvent to create a solution;
adding surface modified microspheres and mixing to form a slurry;
spraying the slurry upon a substrate perpendicularly at a distance of 20-30 cm at a pressure of about 50-60 psi; and
drying the coated substrate at a temperature of about 100° C. for about 1 h.

18. The method of claim 16, wherein the matrix polymer comprises poly(n-butylmethacrylate), polycarbonate, or any combination thereof;
the solvent comprises isopropanol, toluene, or any combination thereof; and
the microspheres comprise a poly(methylmethacrylate) [PMMA] core and a perfluorinated halloysite coating.

19. The method of claim 18, further comprising poly(dimethylsiloxane) [PDMS].

20. The method of claim 17, wherein
the matrix polymer comprises poly(n-butylmethacrylate), polycarbonate, or any combination thereof;
the solvent comprises isopropanol, toluene, or any combination thereof; and
the microspheres comprise a poly(methylmethacrylate) [PMMA] core and a perfluorinated halloysite coating.
